(19) United States
(12) Patent Application Publication
(10) Pub. No.: US 2006/0095364 A1
(43) Pub. Date: May 4, 2006

(54) Real-time foreign exchange services method and apparatus

(76) Inventors: Brian Thomas Hamilton, San Francisco, CA (US); Christopher Huppert, Piedmont, CA (US); Gregg R. Napoli, San Francisco, CA (US); Michael P. Haehn, Columbus, OH (US)

Correspondence Address: GLENN PATENT GROUP, 3475 EDISON WAY, SUITE L, MENLO PARK, CA, 94025, US

(21) Appl. No.: 11/267,112

(22) Filed: Nov. 3, 2005

Related U.S. Application Data
(60) Provisional application No. 60/625,540, filed on Nov. 4, 2004.

(51) Int. Cl. G06Q 40/00

(52) U.S. Cl. 705/37

(57) ABSTRACT

An international foreign exchange (FX) payment solution is provided that offers straight-through processing of FX rate requests, FX contract initiation, and settlement of funds to and from foreign beneficiaries. The invention is based on a system and method of business using a real-time XML messaging interface, open source access, and industry-standard messaging formats. No special hardware or software is required to implement the invention. The invention enables a customer, e.g. a business or Partner Financial Institution, to connect their core back-end systems and customer-facing Internet platforms directly to an enterprise's real-time FX rate engine and foreign settlement capabilities.

### CROSS-REFERENCE TO RELATED APPLICATIONS

This application claims priority to U.S. Provisional Patent Application Ser. No. 60/625,540, filed on Nov. 4, 2004, Attorney Docket Number WELL0049PR, which application is incorporated herein in its entirety by the reference thereto.

### BACKGROUND OF THE INVENTION

1. Technical Field

The invention relates to providing real-time foreign exchange services over the open World Wide Web (Web). More particularly, the invention relates to a transactional Web service using XML and SSL technology over the open Web, that processes foreign exchange rate requests, transactions, and settlements.

2. Description of the Prior Art

On the tails of North American Free Trade Agreement (NAFTA) and of the introduction of the euro, large growth in the international transactions arena can be found. Cross-border business banking continues to grow. Also, it has been becoming more apparent that residents of the United States who are part of the work force are expatriates sending money earned in the United States back to their countries of origin. While business in foreign exchange (FX) services has been booming for businesses and financial institutions (FI) of all sizes, it requires an expensive infrastructure to process FX transactions that many small businesses and FIs may find prohibitive due to large infrastructure investments.

Problems with prior systems include requiring expensive dedicated connections to financial institution back-end processing platforms, expensive licensing and maintenance of proprietary coding standards and software, and no defined XML standard for end-to-end execution and settlement of FX transactions. For Web-related financial exchange servicing, other systems use HTML sites and asynchronous batch file delivery, which are not real-time and cannot offer straight-through processing.

For example, Industrial and Commercial Bank of China (ICBC) on the Foreign Remittance and Clearing System Web page of their Web site (http://www.icbc.com.cn; Home>Corporate Banking>Settlement Business>Foreign Remittance & Clearing System) discuss a foreign remittance and clearing system. This system is developed on the basis of a comprehensive business system platform that takes technical advantage of a domestic fund transfer system in combination with the characteristics of the foreign remittance and clearing business and international practices for handling domestic and overseas foreign remittances, intra-system foreign fund transfers, and foreign exchange fund clearing. Nowhere does the write-up teach or suggest a real-time Web service that provides transactional foreign exchange through a bank's firewalls that provides straight-through processing of FX transactions and their associated settlements.

Cambridge Mercantile Corp. provides an overview of their Global Payment Services department's functional offerings on their Web site (http://www.cambridgefx.com/online/global-payment-services.html). The main components to the system, Cambridgefx Online, are foreign currency exchange, multi-currency accounts, and global payments. It should be appreciated that Cambridgefx Online does not provide a transactional Web service that takes advantage of XML and SSL technology over the open Web.

It would be advantageous to provide a Web service that provides real-time FX transactions through an enterprise's firewalls that provides straight-through processing of the FX transactions and their associated settlements.

It further would be advantageous to provide an open architecture model that uses issued digital certificates, SSL technology, and an XML-based message schema and rules to offer open access to an enterprise's customer (either a business or partner FI).

It further would be advantageous to provide a single online system and business method that processes FX services for an enterprise's customer.

It further would be advantageous to provide a Web service interface that allows an enrolled customer to send and receive synchronous, real-time, XML-based messages through an enterprise's firewall, enabling the enrolled customer to perform FX transactions by using system-to-system direct communication rather than requiring batch delivery or field entry of data on a third party's HTML-based application.

It further would be advantageous to allow a customer to communicate with an enterprise over the open Internet, through a firewall, and into an enterprise's secure environment for the purposes of transacting with an enterprise.

It further would be advantageous to provide a reverse proxy and a double-secure session and live XML-based real-time messages into, and out of, the secure environment so that a customer's server can talk to an enterprise server, communicating from a customer's secure environment to that of an enterprise's secure environment without requiring a dedicated line or a permanently secured line between the two environments.

### SUMMARY OF THE INVENTION

An international FX payment solution is provided that offers straight-through processing of FX rate requests, FX contract initiation, and settlement of funds to and from foreign beneficiaries. The invention is based on a system and method of business using a real-time XML messaging interface, open source access, and industry-standard messaging formats. No special hardware or software is required to implement the invention. The invention enables a customer, e.g. a business or Partner FI, to connect their core back-end systems and customer-facing Internet platforms directly to an enterprise's real-time FX rate engine and foreign settlement capabilities.

### BRIEF DESCRIPTION OF THE DRAWINGS

FIG. 1 is a schematic diagram illustrating a high level architecture according to the invention;

FIG. 2 is a flow diagram illustrating various steps in an FX Service request according to the invention;

FIG. 3 is a schematic flow diagram illustrating a generic request and response pair according to the invention;

FIG. 4 is a schematic flow diagram illustrating creating FX Services contracts and settlement instruction according to the invention;

FIG. 5 is a schematic flow diagram illustrating canceling an FX Services contract according to the invention;

FIG. 6 is a schematic flow diagram illustrating rate cancellation according to the invention;

FIG. 7 is a schematic flow diagram illustrating contract synchronization according to the invention;

FIG. 8 is a schematic flow diagram illustrating a daily FX rate sheet delivery according to the invention; and

FIG. 9 is a schematic flow diagram illustrating a one-step deal add according to the invention.

### DETAILED DESCRIPTION OF THE INVENTION

An international FX payment solution is provided that offers straight-through processing of FX rate requests, FX contract initiation, and settlement of funds to and from foreign beneficiaries. The invention is based on a system and method of business using a real-time XML messaging interface, open source access, and industry-standard messaging formats. No special hardware or software is required to implement the invention. The invention enables a customer, e.g. a business or Partner FI, to connect their core back-end systems and customer-facing Internet platforms directly to an enterprise's real-time FX rate engine and foreign settlement capabilities.

It should be appreciated that herein the use of customer is by way of example only and is not meant to be limiting. Such is an entity is external to the enterprise and could be any entity. For example, a customer can represent any of the following: a software platform provider, a business, a partner Financial Institution with its own Web server, and a third-party's continuous distribution partner that acts as a clearinghouse.

It should be appreciated that by using the invention, customers that do not have the infrastructure to support the international needs of their clients have a direct connection to an enterprise's, such as Wells Fargo's, infrastructure.

Also, for ease of understanding, the discussion herein refers to FX Services. However, it should be appreciated that using the term, service, is not meant to be limiting, but is meant conceptually and includes products and any other kinds of foreign exchange offerings as well.

According to one embodiment of the invention, an enterprise's customer has access to software that enables the customer to initiate FX transactions on its own behalf using the enterprise's infrastructure and thereby reducing the costs associated with providing FX services. By way of example, such services can be provided to the customer as a module that is fully integrated with the customer's cash management and payment-processing platforms.

According to one embodiment of the invention, an enterprise's customer has access to software that enables the customer to initiate FX transactions on behalf of its clients using the enterprise's infrastructure and thereby reducing the costs associated with providing FX services. By way of example, such services can be provided to the customer as a module that is fully integrated with the customer's cash management and payment-processing platforms.

According to one embodiment of the invention, customers are able to initiate FX transactions through a single solution, without phone calls or waiting for transaction confirmations. The invention reduces the need for a customer to double-enter FX transactions, accelerating the completion of FX payments.

It should be appreciated that with the invention, a smaller customer benefits greatly because it can offer its own clients premier FX services without having to invest any capital in technology, while the customer's clients' perception is that they are getting FX services from the smaller customer.

In one embodiment of the invention a customer's server initiates a call to an enterprise's Web server. The enterprise's Web server, unlike a traditional Web server, serves as a reverse proxy, meaning that it manages and marshals all traffic into and out of the enterprise's demilitarized zone (DMZ), which is the area between the enterprise's outermost firewall that touches the external instrument and then the next internal firewall, which regulates all traffic into the enterprise's secure network.

As such, in one embodiment of the invention, an interface connects the customer's core back-end systems or client-facing Internet platforms directly to the enterprise's real-time FX services without special hardware, software, or expensive dedicated network connections.

In one embodiment of the invention, FX rate requests, FX contracts, and FX settlements are processed using a state-of-the-art interface based on open-source access and industry-standard messaging formats.

It should be appreciated that a customer can expand its payment service offerings, create additional revenue streams and gain a competitive advantage, all with the confidence that comes from working with and integrating with an enterprise's trading and service operations. For example, a small bank can integrate with Wells Fargo and thereby work with and integrate with the only Aaa-rated bank in the United States.

Benefits

Some benefits the customer realizes as a result of using the enterprise's system and method of processing FX transactions are listed and described below.

Enhanced FX Service Capabilities

The invention allows the customer to buy and sell a wide range of currencies using foreign drafts or wire transfers either on the spot market or via forward contracts. Connecting directly to the customer's existing platforms, the interface provides an integrated and seamless user experience.

Efficiency

The enterprise's well-established currency trading operation and extensive foreign correspondent banking network, such as that of Wells Fargo, enable the customer to manage market-rate risk and offer clients of the customer a complete range of FX services without the customer having to build and maintain FX trading infrastructure. Straight-through processing minimizes the customer's staffing requirements and greatly diminishes the chance of human error or payment fraud.

Additional Revenue

With more control over the transaction process, the customer can build in its own transaction margins and better manage its revenue stream.

24-Hour-A-Day Trading and Execution

The invention provides the customer with competitive, real-time market rates and allows the customer to execute transactions 24 hours a day, 7 days a week, 365 days a year.

Round-The-Clock Technical and Operational Support

Application support and investigation resources are at the fingertips of the customer for a fraction of the cost of developing and maintaining these services in-house.

Professional Implementation Support

The enterprise can provide professional consultants and knowledgeable project managers to help the customer with testing and implementation.

Security

The invention uses Secure Socket Layer (SSL) technology and 128-bit encryption to ensure that FI transactions are secure and FI information is safe.

State-Of-The-Art Technology

Foreign exchange rate requests, transaction initiation, and settlement are handled by an XML-based interface using open source access standards and the IFX messaging format.

High-Level Architecture

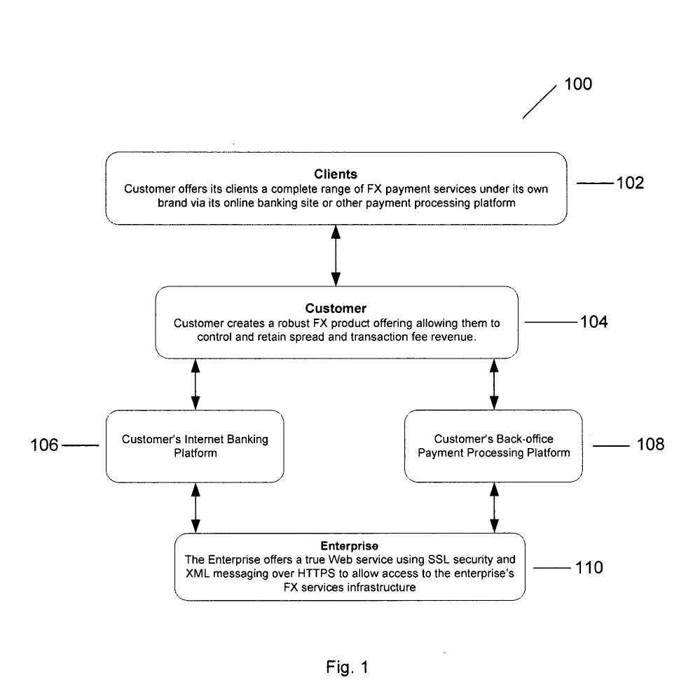

A high level architecture of one embodiment of the invention from the perspective of a customer is described with reference to FIG. 1, a high level schematic diagram 100. A customer offers its clients a complete range of FX services and/or products under the customer's brand, for example, via an online banking Web site or another payment-processing platform 102. The customer creates a robust FX product offering that allows a customer to control and retain spread and transaction-fee revenue 104. The FX product is communicatively coupled to either the customer's Internet banking platform 106 and the customer's back-office payment-processing platform, or both 108. The two platforms are communicatively coupled to the FX Web service of the enterprise, for example to Wells Fargo's WellsXchange, by using SSL security and XML messaging over HTTPS 110.

A High-Level FX Service Request Process

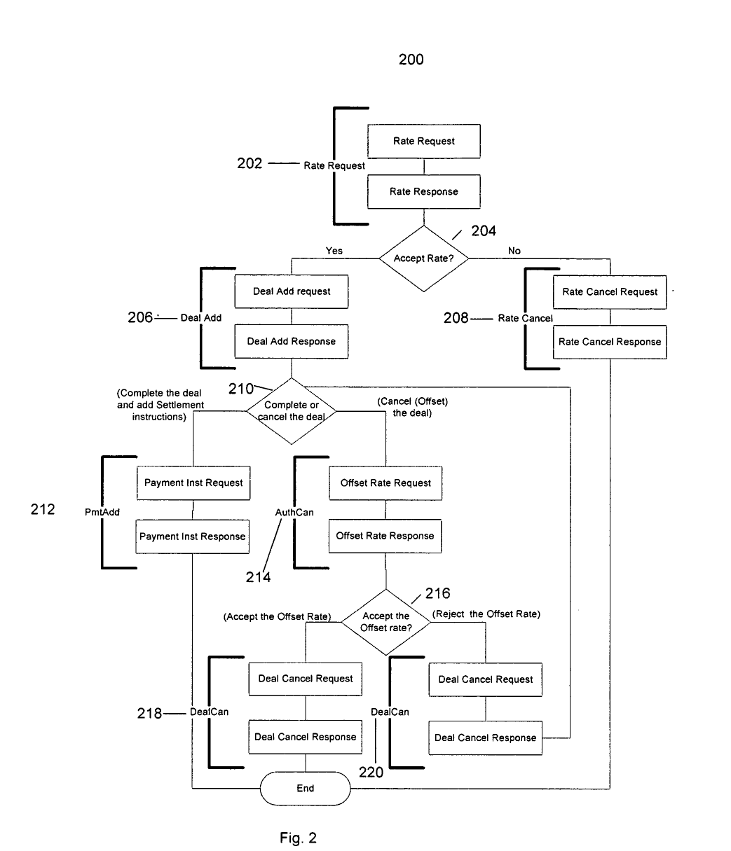

One embodiment of the invention can be described with reference to FIG. 2, a flow diagram illustrating various steps in an FX Service request and response according to the invention 200. A customer makes a rate request to which a rate response is returned 202. Such rate request can be on behalf of the customer itself or on behalf of a customer's client.

The customer indicates whether or not it accepts the rate 204. If the rate is not accepted by the customer, then a rate cancel request is generated to which a rate cancel response is returned 208. The process ends. If the rate is accepted by the customer, then a contract request is generated to which a contract response, containing contract information, is returned 206. It should be appreciated that the terms, contract and deal, are used herein interchangeably. Specifically, generating a contract can be referred to herein as a Deal Add.

Upon receiving the Deal Add response 206, the customer indicates whether to complete or cancel the contract 210. If the customer indicates completing the deal, then settlement or payment instructions are requested to which settlement or payment instructions are returned 212. The process ends.

If the customer indicates canceling or offsetting the contract or deal, then an offset rate request and response are respectively generated 214. Such offset rate request and response pair are referred to herein also an authorize cancel (AuthCan) request and response pair.

Upon receiving the offset rate response, the customer indicates whether to accept or reject the offset rate by submitting a deal cancel (DealCan) request message 216. If the customer indicates to accept the offset rate, then an internal flag in the DealCan request message is set to Yes, indicating to end the first contract. Offsetting information is returned in the DealCan response 218. The process ends. If the customer indicates to reject the offset rate, then an internal flag in the DealCan request message is set to no, indicating to leave the original contract in place. No offsetting information is returned in the DealCan response 220. The process returns to the block determining whether to complete or cancel the contract 210.

Fundamental Architecture

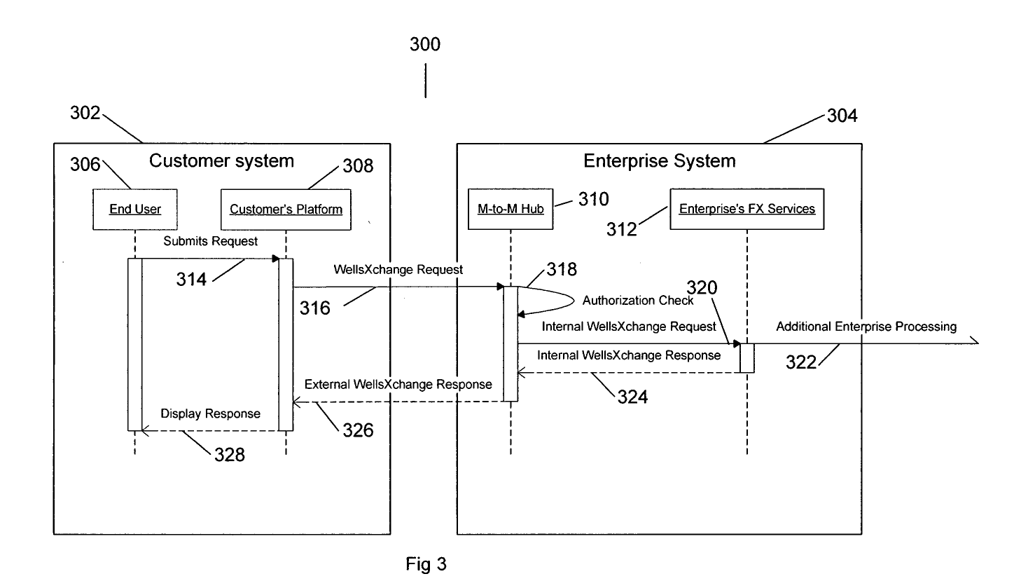

Referring to FIG. 3, a schematic flow diagram of a generic request and response pair 300 is illustrated. A conceptual customer system 302 contains an end-user entity 306 and the customer's platform 308. A conceptual enterprise system 304 contains an M-to-M hub component 310 and an enterprise's FX Services component 312.

A generic request and response completion according to the invention can be described as follows. The end-user submits a request 314 which is received by the customer's platform, e.g. from the user's keyboard to the customer's Web site. The customer platform generates a request in a well-know format by the enterprise's system, sometimes referred to herein as a WellsXchange request 316. The format of the request, referred to herein as a WellsXchange request, and return response, referred to herein as a WellsXchange response, are XML format. The customer platform 308 sends the WellsXchange XML message to the enterprise's M-to-M hub 310.

According to one embodiment of the invention, the M-to-M hub performs the following duties. The M-to-M hub authenticates connectivity using SSL security. It processes SOAP headers and sends SOAP messages to the enterprise's FX system 312. M-to-M authenticates customers' request messages, for example, using digital certificates and SOAP header information. M-to-M determines whether or not a connection to the enterprise's FX services is to be opened based on the customer identification credentials as well as the certificate credential itself.

That is, the M-to-M hub enables WellsXchange messaging by using SSL security for authentication and XML messaging to and from both the customer's platform and the enterprise's FX Service server or application over the Internet.

Hence, the invention provides for authenticating a request for a secure session. It should be appreciated that a second and separate secure session is then opened, also referred to herein as the internal WellsXchange request 320 and is sent to the enterprise's FX Services component. Such second session 320 is not from the same client call into the secure environment 316. That is, the invention manages two separate concurrent sessions, one with the customer and one with the enterprise's FX Services infrastructure. This system and method ensures that not a single connection is made all the way into the enterprise's secure environment.

It should be appreciated that the additional processing 322 is beyond the FX Services application server or component and is outside of the scope of this discussion.

Upon receiving the internal WellsXchange request 320, the enterprise's FX Services component returns a WellsXchange response 324 back to the M-to-M hub, which, in turn, generates and returns an external WellsXchange response 326 back to the customer's platform. The customer's platform generates and sends a response, herein referred to as a display response 328, to the end-user entity.

It should be appreciated that the implementation can include less than or more than three conceptual servers and that the description hereinabove is meant to be by way of example only for clarification purposes.

It should be appreciated that the invention allows authentication by way of digital certificates. For example, according to one embodiment of the invention, a digital certificate is issued by the enterprise to the appropriate system of the customer such that the digital certificate is subsequently presented by the customer's system for the purposes of system-to-system XML communication without requiring or having a permanent dedicated connection to the environment of the enterprise. Such digital certificates are machine specific, that is, each server that wants to communicate with the enterprise requires a valid digital certificate and digital certificates are issued to every machine that communicates with the enterprise. Because the enterprise is the certificate-issuing authority, it embeds in the issued certificate customer-specific identification information that may be used for authentication when the certificate is presented. The customer configures its associated servers to make an SSL connection to the enterprise's server and present the issued certificate. The enterprise interrogates it, validates it, and passes the customer's request message to the enterprise's FX services. The enterprise then provides a corresponding real-time synchronous response. Once the response is provided, the enterprise destroys the SSL connection. Should the customer need to send another message, the customer presents the certificate again.

Contract and Settlement Instruction Process

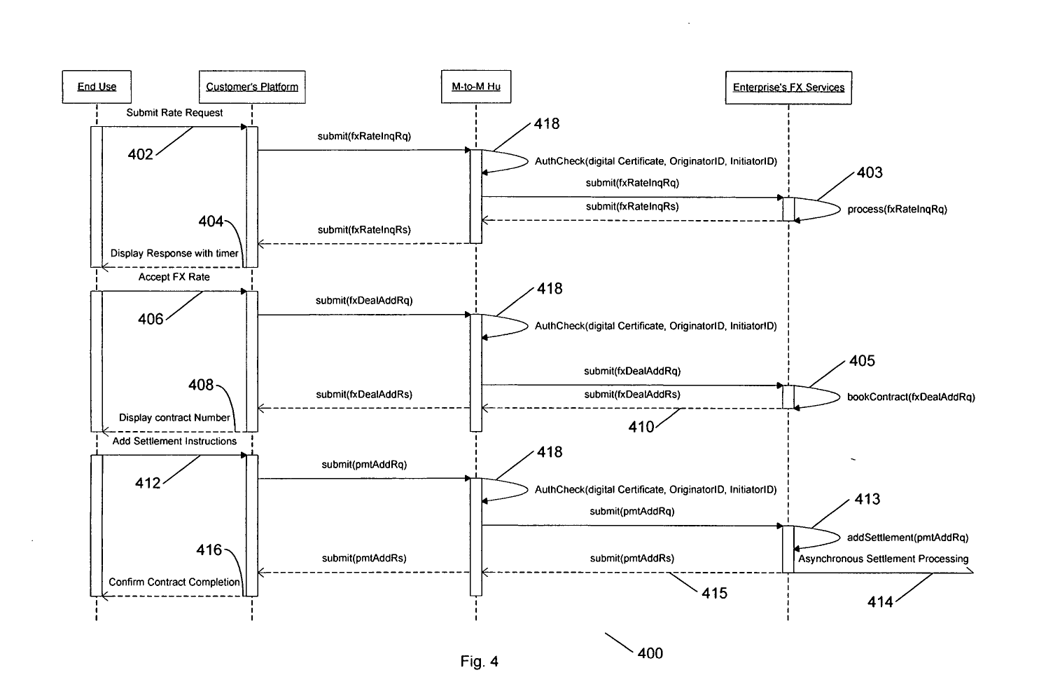

Referring to FIG. 4, the WellsXchange requests and responses of FIG. 3 for an FX contract and a settlement instruction 400 are shown. The end-user initiates a submit rate request 402 and after the complete WellsXchange message cycle of FIG. 3, including the enterprise FX Services component processing the rate request 403, the end-user receives a display response with a timer 404.

The timer mechanism for real-time FX acceptance measures a particular time value as follows. When the enterprise provides a response to a rate request, the enterprise provides the customer a time value indicating the time by which an acceptance of the rate (i.e. a DealAdd request message) must be received by the enterprise. If the enterprise does not receive a reply by the time indicated in the response message the enterprise sends the customer a ‘rate expired’ message back.

If the end-user accepts the rate displayed a rate acceptance request message, i.e. DealAdd, to the enterprise. If the acceptance request is received before the expiration time indicated in the rate response from the enterprise 406, then the enterprise books a contract 405 and passes a contract number in a Deal Add response message 410. The end-user receives a display of contract information and the contract number 408.

If the end-user accepts the contract, then the end-user initiates an add settlement instructions request 412. The request gets propagated as in FIG. 3 to the enterprise's FX Services component, which processes the settlement or payment request asynchronously 414. The enterprise's FX Services component also sends a synchronous submit payment add response 415 and the end-user receives a confirm contract completion response 416.

It should be appreciated that the M-to-M hub performs an authentication check process each time it receives a WellsXchange request from the customer platform 418.

Unwinding an FX Services Contract

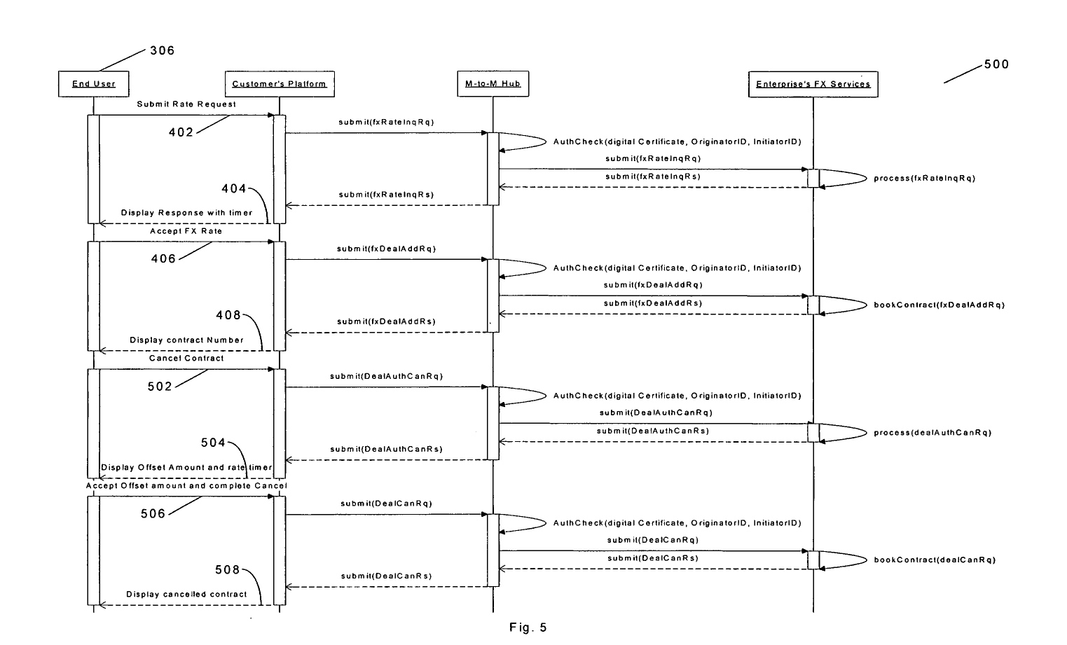

Referring to FIG. 5, the ability to offset or unwind an FX contract 500 according to an embodiment of the invention is described. As an example, suppose a customer booked a contract but made a mistake and typed in one million instead of one hundred thousand and the customer hadn't added instructions yet. Then the customer can post a separate and subsequent request stating ‘Unwind that contract.’ In one embodiment of the invention, the enterprise unwinds the contract and provides the customer with positive or negative dollars in the response, accordingly, and an offsetting contract confirmation.

Unwinding a contract is basically comprised of four successive request and response pairs from and to the end-user 306 as follows. As described hereinabove, the end-user initiates a submit rate request 402 and receives a display response with timer 404. The end-user initiates an accept FX rate request 406 and receives a display contract number 408 as described hereinabove. The end-user initiates a cancel contract request 502. Because it is a type of WellsXchange request of FIG. 3, the same basic steps are taken, resulting in the end-user receiving a display offset amount and rate timer response 504. Finally, the end-user initiates an accept offset amount and complete cancel request 506 and receives a display cancelled contract response 508.

Rate Cancel Process

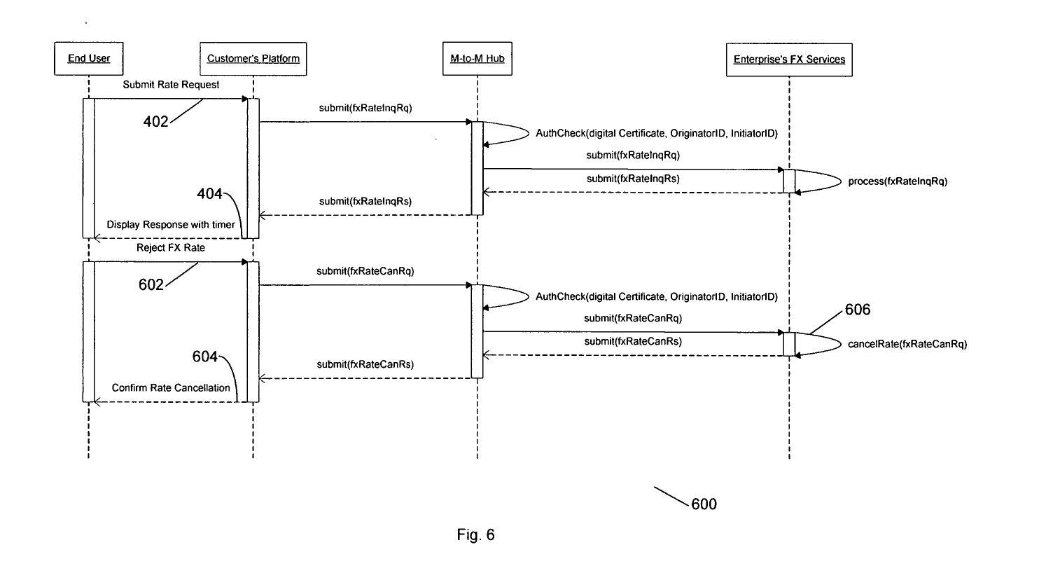

It should be appreciated that other logical paths are provided. For example, the end-user can reject a rate or the end-user can send instructions that are bad or in error. FIG. 6 shows a WellsXchange request for rate cancellation according to an embodiment of the invention. The end-user submits a rate request 402 and received a display response with timer 404 as discussed hereinabove. In this example, the end-user decides to cancel the rate. The end-user sends a reject FX rate request and receives a confirm rate cancellation response 604. The enterprise FX Services component processed the FX rate cancel request 606.

Contract Synchronization Service

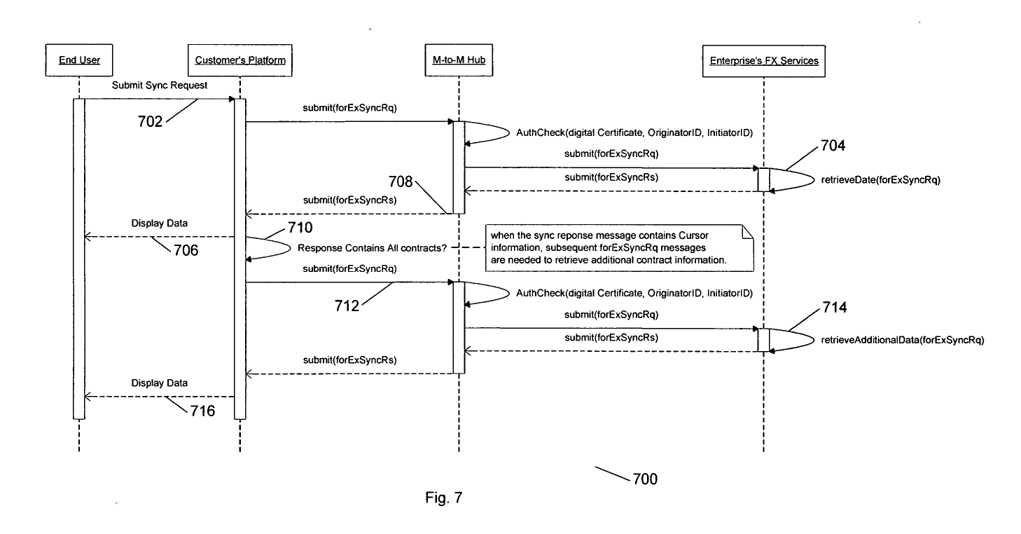

Referring to FIG. 7, a data or contract synchronization (sync) service 700 according to the invention can be described. Such service 700 can be used on a daily basis or as frequently as desired by an end-user. It is a synchronization or a ‘Tell me everything you have in your database for me today’ that ensures that if the end-user asked for a contract but never got a response back because perhaps the connection malfunctioned in the middle of the request for example, the end-user is in synchronization with the databases of the enterprise. That is, this service enables the end-user to know everything the enterprise has on the books for the end-user for a given time period. Such service enables database synchronization and reconciliation from a contract perspective.

In one embodiment of the invention, the end-user initiates a submit sync request 702. The enterprise's FX Services component performs a retrieve date process and returns a display data response 706 to the end-user. Responsive to receiving the submit sync response 708, the customer determines if the response contains all contracts of the end-user 710. If not, the customer submits one or more subsequent requests to retrieve additional contract information 712. The enterprise's FX Services component processes such request 714 and sends a submit sync response back and the end-user receives a display data response containing the additional contract information.

According to one embodiment of the invention, the enterprise's FX Services component sends the customer contract details for all contracts that have been altered within the selected start and endpoints indicated in the request message. The enterprise can also provides additional information that the end-user has not received in any other response message, because, for example, such additional information may not have been available at the time of an earlier message response. For example SWIFT ISN information is only available after a SWIFT confirmation is received; SWIFT confirmations may take several hours to receive.

It should be appreciated that in one embodiment of the invention, the customer's platform's use of the data from the enterprise's FX Service component's responses are not limited to display, but can be used for further processing, such as for example purposes.

A Daily FX Rate Sheet

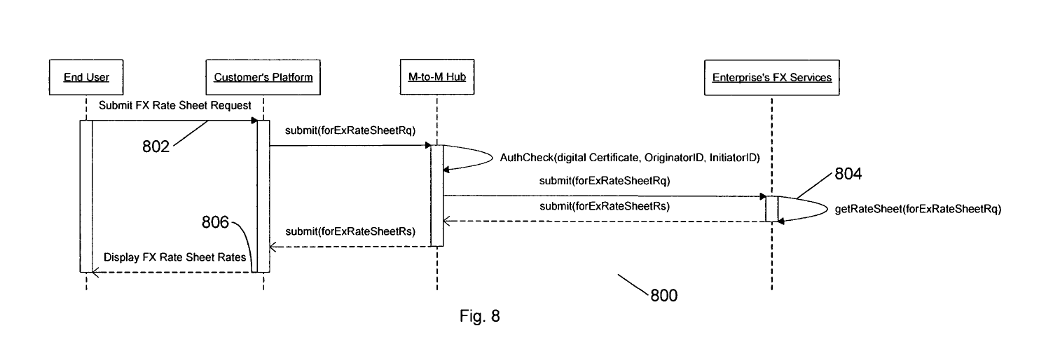

One embodiment of the invention allows for providing a daily FX rate sheet that contains predetermined rates applied to all FX transactions up to a currency threshold, e.g. up to $15,000 USD. Referring to FIG. 8, a schematic flow diagram illustrating a daily FX rate sheet delivery 800 according to an embodiment of the invention, an end-user sends a submit FX rate sheet request 802, which is specific to that customer. The enterprise's FX Services component process the request 804 and returns a rate or a series of rates, which the end-user receives in a display FX rate sheet response 806. For example, the enterprise can return a rate or series of rates for every currency that the enterprise deems available for daily rate sheet pricing. As another example, the rates are provided in a single response with a message indicating that such rates are valid for a certain time period, such as that day. The end-user and/or the customer can then take and propagate the information in a way appropriate to the way either the end-user or the customer conducts business.

It should be appreciated that the daily rate sheet only contains predetermined FX rates. No financial transaction occurs when the enterprise provides the rate sheet. However, this service allows knowing the FX rate prior to making a FX request to the enterprise.

It should further be appreciated that in one embodiment of the invention, the customer's platform's use of the data is not limited to display, but can be used for further processing, such as for example purposes.

A One-Step Deal Add Process

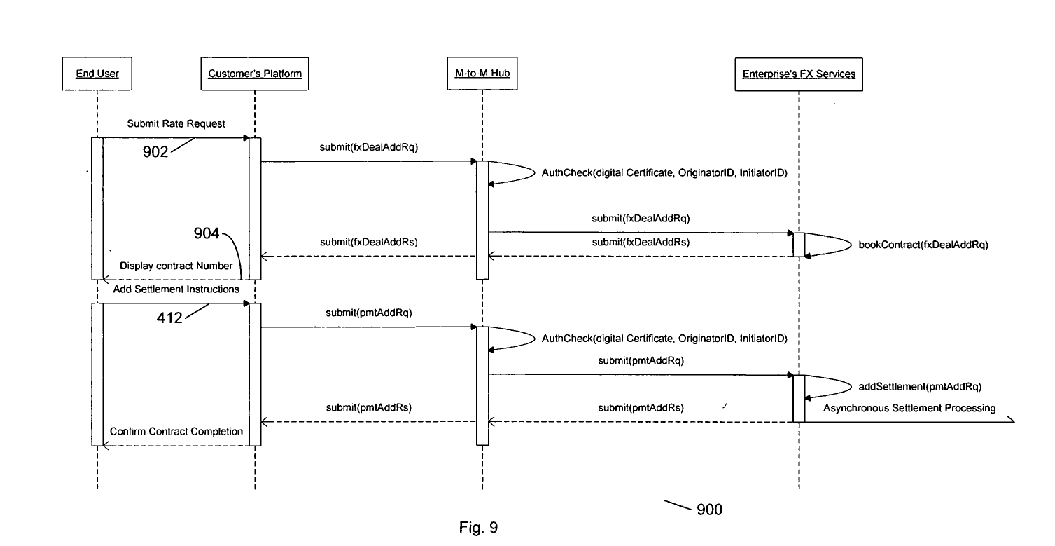

An alternate embodiment of the invention can be described with reference to FIG. 9. A customer makes a Deal Add request with Rate Request message information and a contract is returned to the customer 904 in the Deal Add Response message 904. It is understood between the enterprise and the customer that the customer automatically accepts the rate and the contract presented in the response message 904. Then settlement instructions 412 are added to a contract that is created by using the same Add Settlement Instructions message described earlier herein and as illustrated in FIG. 4 to obtain a confirmed contract completion.

It should be appreciated that contracts generated using this alternate embodiment are fundamentally the same as a contract negotiated using Rate Request and Deal Add messages outlined above and as illustrated in FIG. 4.

### An Exemplary Real-Time Foreign Exchange Web Service

The following teaching and discussion is taken from an exemplary Wells Fargo implementation guide of one embodiment of the invention. It should be appreciated that certain implementation details are meant by way of example only and are not meant to be limiting, for example, by Wells Fargo is meant any enterprise, and so on.

One embodiment of the invention is described hereinbelow which includes an FX Service applications server, a Machine-to-Machine (M-to-M) Hub, and interfaces required to transact foreign exchange trading, settlement, and administrative activities. The discussion hereinbelow is meant to be technical, but also provides beneficial information to technology managers, project managers, testing staff, and business systems analysts.

WellsXchange Overview

WellsXchange is a service that enables Wells Fargo and its Distribution Partners (either a Partner Financial Institution (Partner FI) or a Service Provider, which is an organization that support a Financial Institution) to execute third-party FX transactions. This service allows the Distribution Partner's end-users, e.g. other banks and customers, to enter into FX contracts through Wells Fargo Bank and settle those contracts through foreign beneficiaries.
The Distribution Partner is responsible for building and managing the client application for end-users to interact.
Wells Fargo Bank, via WellsXchange, provides FX rates, manages trade execution, and initiates settlement instructions on behalf of the Distribution Partner and its end-users.
WellsXchange provides the FX rate for each transaction.
WellsXchange acts as the transaction engine to process payment for FX transactions.
Communication to WellsXchange is handled through a portal called the Machine-to-Machine (M-to-M) Hub.
The message interface is defined in XML and is based upon Interactive Financial exchange (IFX) message formats using SOAP 1.1 as an envelope.
Communications is over TCP/IP leveraging 128-bit encryption and Secure Socket Layers (SSL).
Authentication for communications is via Digital Certificates.
   Distribution Partner Specifications

To perform FX transaction with Wells Fargo through the WellsXchange service, the Distribution Partners:
Are setup with a Wells Fargo issued Digital Certificate.

Are setup with Wells Fargo assigned ID's, established through the enrollment process.
Send a SOAP 1.1 envelope over HTTPS to a predetermined URL via the Distribution Partner client application using SSL. The SOAP envelope contains a single XML “request”, WS-Addressing in the SOAP Header, and formatted IFX/XML in the SOAP Body. An SSL session is created for every request and WellsXchange closes the session upon the transmission of the response.
Maintain an SSL session until a response is received. A session is created for every request and WellsXchange closes the session upon the transmission of the response.

The client application supports functionality as to be able to:
Wait for a predetermined timeframe to receive a response to each SOAP message request that it sends.
Upon receiving a response from WellsXchange, send a subsequent SOAP message request as appropriate.
Be capable of handling multiple sessions simultaneously in a thread-safe manner.

It should be appreciated that Wells Fargo provides all necessary connectivity information, interface documentation, and XML artifacts, e.g. XML Schemas and WSDL documents, for the Distribution Partner to develop and connect to the enterprise.

Key Events and Milestones

To connect to the WellsXchange service, in one embodiment of the invention, the following key events and milestones are completed:
Distribution Partner signs contracts.
Wells Fargo delivers documentation to Distribution Partner.
Wells Fargo schedules and completes walk-through of documentation with Distribution Partner.
Distribution Partner provides necessary information to begin setup/enrollment process, such as Distribution Partner IP addresses, Digital Certificate enrollment information.

Test environment milestones:
Wells Fargo enables Distribution Partner IP addresses through Wells Fargo firewalls.
Wells Fargo creates Distribution Partner profile in test environment.
Wells Fargo sends digital certificates and ID's to Distribution Partner.

Production environment milestones:
Wells Fargo reconfirms enrollment information for production environment.
Wells Fargo creates company profile in production environment.
Wells Fargo distributes digital certificates to Distribution Partner.
   Setup and Enrollment

Upon the completion of contract agreements between Wells Fargo, and the Distribution Partner, the Distribution Partner receives all necessary documentation to perform development tasks, plan for testing, and connect to Wells Fargo. Distribution Partners receive the following documentation:
WellsXchange Interface XML Schemas and WSDL Documents.
WellsXchange Implementation Guide.
WellsXchange Customer Reference Guide.
WellsXchange Use case documents (including sample XML).
WellsXchange Partner Test Plan.

Distribution Partners provides the following information used to setup digital certificates, routing information, and other credential information:
Distribution Partner's Name. This may be the same as the Partner FI's name if the Partner FI is acting on their own behalf.
Company Name.
Distribution Partner locality, e.g. City, State/Province, and Country.
Distribution Partner server administrator Name, Phone Number, Email Address, Physical Address. The enterprise, i.e. Wells Fargo distributes Digital Certificate information to the server administrator.
Server Name, e.g. DNS Name, Server Physical IP address that are used for digital certificates, see hereinbelow.

Wells Fargo works with the Distribution Partner to enroll the Distribution Partner in the Wells Fargo environment. Upon completion, Wells Fargo provides the following information to the Distribution Partner:
Digital Certificate.
Routing information via WS-Addressing: ProductId, SPName, PartnerFI (user Id).

Additional information may need to be provided during Test and Production setup and is handled by Wells Fargo. In addition to this information, the Distribution Partner provides enrollment information for each Partner FI they service.

Enterprise (Wells Fargo) Environment Details

The WellsXchange service provides a Machine-to-Machine (M-to-M) Hub as an entry point into Wells Fargo Bank. This platform performs the necessary authentication and authorization activities to transact business between Wells Fargo Bank and a Distribution Partner. Authentication is handled via digital certificates, which are provided by the Wells Fargo.

The following sections provide details specific to the WellsXchange environment that the Distribution Partner is aware of when communicating with Wells Fargo via M-to-M.

Digital Certificates

Wells Fargo leverages digital certificates for an authentication mechanism, which Wells Fargo distributes to the Distribution Partner. This process is coordinated by Wells Fargo and requires the Distribution Partner to request a digital certificate via a Certificate Signing Request (CSR) process. Specific information about the Distribution Partner is part of the CSR that creates a Distinguished Name (DN), a unique representation of a party or system within a digital certificate.

Additional Notes

It should be appreciated that digital certificates are provided in DER format. Distribution Partners receive their client digital certificate and the certificate chain to trust their own certificate, which includes the Wells Fargo Certificate Authority certificate and the GTE CA root certificate. Separate certificates are issued for test and production environments, regardless of whether or not both environments are managed on the same physical hardware. Distribution Partners are not required to request a certificate for each Partner FI that the Service Provider acts on behalf of. However, each Partner FI is associated with the Service Provider ID through the enrollment process, i.e. after the initial implementation when a Distribution Partner offers WellsXchange services to a new Partner FI, the enrollment process is revisited to assign the new Partner FI an ID. A new digital certificate is not required in this case.

Connectivity

Wells Fargo M-to-M allows for Internet connections with 128-bit SSL encryption through port 443, the standard HTTPS protocol port, by requests that contain client digital certificates. Communication to Wells Fargo requires Distribution Partners to configure firewall rules to allow communication from the following Wells Fargo URI's.

It should be appreciated that Wells Fargo leverages load balancing and routes transactions to the next available server in the M-to-M pool; therefore, IP addresses should not be hard-coded, rather, the DNS name should be provided.

Distribution Partners may maintain their own timeout windows; however, some requests may take longer to process than others. In one embodiment of the invention, the Wells Fargo session timeouts are 15 seconds with the exception of RateInq, ForExSync, and AuthCan, i.e. the Offset request message, which may take as long as five minutes.

The Distribution Partners maintain a thirty-second Time To Live (TTL) for communication with M-to-M. Such high availability technology only distributes IP addresses of available servers; therefore, it is necessary to honor the TTL to maintain high availability. Any server or application caches of the DNS record are not to be long lived. In the event of a server becoming unavailable, whether planned or unplanned, by honoring this TTL, unexpected outages should only be the duration of the TTL time.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A system that provides a foreign exchange (FX) Web service in real-time, comprising:
a customer system comprising:
means for submitting an FX request in XML over the Internet to initiate an FX service; and
responsive to said submitted FX request, means for receiving an external FX response in XML over the Internet; and
an enterprise system comprising a machine to machine (M-to-M) hub and an enterprise FX Services component, said enterprise system comprising:
means for said M-to-M hub receiving said submitted FX request in XML from said customer system;
responsive to said receiving said submitted FX request in XML, means for said M-to-M hub performing an authentication process using said submitted FX request;
responsive to a positive result of said authentication process, means for said M-to-M hub generating and submitting an internal FX request to said enterprise FX Services component for additional enterprise processing;
responsive to receiving said internal FX request, means for said enterprise FX Service component generating and sending an internal FX response to said M-to-M hub;
responsive to receiving said internal FX response, means for said M-to-M hub generating and sending an external FX response to said customer system.

2. The system of claim 1, wherein said customer system comprises an end-user entity and a customer's platform wherein the end-user entity initiates an end-user submitted FX request to the customer platform for processing and wherein the customer platform returns a display response to said end-user entity.

3. The system of claim 1, wherein said M-to-M hub comprises means for:
authenticating using SSL security and digital certificates and SOAP header information;
processing SOAP headers and sending SOAP messages; and
returning SOAP errors.

4. The system of claim 1, wherein said FX Web service is any of or any combination of:
contract and settlement instruction;
unwinding an FX contract;
rate cancellation;
contract synchronization;
daily FX rate sheet delivery; and
one-step deal add.

5. The system of claim 4, wherein contract and settlement instruction further comprises:
a submit rate request and response with timer;
an accept FX rate request and display contract number response;
an add settlement instructions request and a confirm contract completion response.

6. The system of claim 4, wherein unwinding an FX contract further comprises:
a submit rate request and response with timer;
an accept FX rate request and display contract number response;
a cancel contract request;
a display offset amount and rate timer response;
an accept offset amount and complete cancel request; and
a display cancelled contract response.

7. The system of claim 4, wherein rate cancellation further comprises:
a submit rate request and response with timer;
a reject FX rate request; and
a confirm rate cancellation response.

8. The system of claim 4, wherein contract synchronization further comprises:
a submit sync request;
a first display contract data response;
a determining if said display contract data response contains all contracts and, if not, then submitting a retrieve additional contract data request; and
responsive to said submitted retrieve additional data contract request, providing a second display data response.

9. The system of claim 4, wherein daily FX rate sheet delivery further comprises:
a submit FX rate sheet request and a display FX rate sheet response.

10. The system of claim 2, wherein said submitted FX request in XML is either on behalf of said customer's platform or on behalf on said end-user entity.

11. The system of claim 2, wherein said customer platform offers features of said enterprise's FX Services to said end-user entity under the customer's brand.

12. The system of claim 4, wherein unwinding an FX contract further comprises:
upon receiving an offset rate response, a customer indicating whether to accept or reject an offset rate;
if said customer indicated accept the offset rate, then an offset value is set to yes, indicating to end an original contract, and a deal cancel request with said offset value and response pair are generated respectively;
if said customer indicated to reject the offset rate, then an offset value is set to no, indicating to leave said original contract in place, and a deal cancel request with said offset value and response pair are generated, respectively, and returning the process to the a step of determining whether to complete or cancel the contract.

13. The system of claim 4, wherein one-step deal add further comprises:
a submit rate request and response without timer;
an automatic accept FX rate request and display contract number response; and
an add settlement instructions request and a confirm contract completion response.

14. A method that provides a foreign exchange (FX) Web service in real-time, comprising the steps of:
providing a customer system that:
submits an FX request in XML over the Internet to initiate an FX service; and
responsive to said submitted FX request, receives an external FX response in XML over the Internet; and
providing an enterprise system, comprising a machine to machine (M-to-M) hub and an enterprise FX Services component, wherein:
said M-to-M hub receives said submitted FX request in XML from said customer system;
responsive to said received said submitted FX request in XML, said M-to-M hub performs an authentication process using said submitted FX request;
responsive to a positive result of said authentication process, said M-to-M hub generates and submits an internal FX request to said enterprise FX Services component for additional enterprise processing;
responsive to receiving said internal FX request, said enterprise FX Service component generates and sends an internal FX response to said M-to-M hub; and
responsive to receiving said internal FX response, said M-to-M hub generates and sends an external FX response to said customer system.

15. The method of claim 14, wherein said customer system comprises an end-user entity and a customer's platform wherein the end-user entity initiates an end-user submitted FX request to the customer platform for processing and wherein the customer platform returns a display response to said end-user entity.

16. The method of claim 14, wherein said M-to-M hub provides means for:
authenticating using SSL security and digital certificates, source IDs, and CEO IDs;
processing SOAP headers and sending SOAP messages; and
returning SOAP errors.

17. The method of claim 14, wherein said FX Web service is any of or any combination of:
contract and settlement instruction;
unwinding an FX contract;
rate cancellation;
contract synchronization;
daily FX rate sheet delivery; and
one-step deal add.

18. The method of claim 17, wherein contract and settlement instruction further comprises:
a submit rate request and response with timer;
an accept FX rate request and display contract number response;
an add settlement instructions request and a confirm contract completion response.

19. The method of claim 17, wherein unwinding an FX contract further comprises:
a submit rate request and response with timer;
an accept FX rate request and display contract number response;
a cancel contract request;
a display offset amount and rate timer response;
an accept offset amount and complete cancel request; and
a display cancelled contract response.

20. The method of claim 17, wherein rate cancellation further comprises:
a submit rate request and response with timer;
a reject FX rate request; and
a confirm rate cancellation response.

21. The method of claim 17, wherein contract synchronization further comprises:
a submit sync request;
a first display contract data response;
a determining if said display contract data response contains all contracts and, if not, then submitting a retrieve additional contract data request; and
responsive to said submitted retrieve additional data contract request, providing a second display data response.

22. The method of claim 17, wherein daily FX rate sheet delivery further comprises:
a submit FX rate sheet request and a display FX rate sheet response.

23. The method of claim 15, wherein said submitted FX request in XML is either on behalf of said customer's platform or on behalf on said end-user entity.

24. The method of claim 15, wherein said customer platform offers features of said enterprise's FX Services to said end-user entity under the customer's brand.

25. The method of claim 17, wherein unwinding an FX contract further comprises:
upon receiving an offset rate response, a customer indicating whether to accept or reject an offset rate;
if said customer indicated accept the offset rate, then an offset value is set to yes, indicating to end an original contract, and a deal cancel request with said offset value and response pair are generated respectively;
if said customer indicated to reject the offset rate, then an offset value is set to no, indicating to leave said original contract in place, and a deal cancel request with said offset value and response pair are generated, respectively, and returning the process to the a step of determining whether to complete or cancel the contract.

26. The method of claim 17, wherein one-step deal add further comprises:
a submit rate request and response without timer;
an automatic accept FX rate request and display contract number response; and
an add settlement instructions request and a confirm contract completion response.
